(19) United States
(12) Patent Application Publication
(10) Pub. No.: US 2025/0214453 A1
(43) Pub. Date: Jul. 3, 2025

(54) METHOD FOR CONTROLLING ELECTRIC TWO-WHEEL VEHICLE

(71) Applicant: HONDA MOTOR CO., LTD., Tokyo (JP)

(72) Inventors: Eiji Kittaka, Minato-ku, Tokyo (JP); Yoshiaki Tsukada, Minato-ku, Tokyo (JP); Takashi Ozeki, Minato-ku, Tokyo (JP); Yasushi Fujimoto, Minato-ku, Tokyo (JP)

(21) Appl. No.: 18/850,918

(22) PCT Filed: Jan. 24, 2023
(86) PCT No.: PCT/JP2023/002113

§ 371 Date: Sep. 25, 2024

(30) Foreign Application Priority Data
Mar. 29, 2022 (JP) 2022-054639

(51) Int. Cl. B60L 15/20

(52) U.S. Cl. CPC B60L 15/2072; B60L 2200/12; B60L 2240/12; B60L 2240/421; B60L 2240/423; B60L 2240/507

(57) ABSTRACT

A method for controlling an electric two-wheel vehicle that enables a rider to start driving without a sense of discomfort when operating a clutch to perform a start operation. The control method is a method for controlling an electric two-wheel vehicle, the electric two-wheel vehicle including a motor, a clutch, and a stepped transmission, the method including: a disengagement detecting step of detecting a transition from a state in which the clutch is disengaged to a state in which the clutch is engaged; an accelerator operation detecting step of detecting an amount of accelerator operation performed by a rider after the engagement of the clutch; a target motor rotation speed setting step of setting a target motor rotation speed based on the accelerator operation amount; and a motor rotation speed controlling step of controlling a rotation speed of the motor based on the target motor rotation speed.

### TECHNICAL FIELD

The present invention relates to a method for controlling an electric two-wheel vehicle.

### BACKGROUND ART

Saddle-ride vehicles such as a motorcycle are attractive in that a rider can directly convey his or her intention to the vehicle and operate it to drive as if it was a part of his or her body. Examples of an object to be operated in a conventional saddle-ride vehicle driven by an internal combustion engine include throttle opening and closing adjustment using a throttle grip, braking, and stepped gear change with a clutch operation, which enable the rider to drive freely. Due to growing interest in environmental issues in recent years, electric two-wheel vehicles driven by electric motors have been developed as saddle-ride vehicles. Among them, an electric two-wheel vehicle provided with a clutch mechanism that cuts off a motor and a gear train from each other is also disclosed (e.g., refer to International Publication No. WO 2014-102869).

### CITATION LIST

### Patent Literature

### [Patent Literature 1]

International Publication No. WO 2014-102869

### SUMMARY OF INVENTION

### Technical Problem

However, in a case in which the clutch mechanism is included, when a clutch is operated to make a start, regarding a load change caused when the clutch is changed from a disengaged state to an engaged state, a large drop in the rotation speed of the motor occurs due to a too small inertia weight on a motor shaft, and the rider may disadvantageously feel a sense of discomfort. In addition, there is a large difference between the torque characteristic of a motor and the torque characteristic of an internal combustion engine. For example, in a motorcycle driven by an internal combustion engine, even if the rider opens a throttle at the start of driving, there is a time lag until the rotation speed actually rises and the torque increases because multiple processes such as air intake, fuel injection, and combustion start are gone through. In other words, the torque increases as the rotation speed rises. On the other hand, in an electric two-wheel vehicle, a large torque can be obtained immediately after the start of driving because a large torque can be obtained even at low-speed rotation as a characteristic of a motor (refer to FIG. 2). Thus, in an electric two-wheel vehicle, it is necessary to control the output of the motor to prevent the rider to feel a sense of discomfort at abrupt start or the like. The present invention provides a method for controlling an electric two-wheel vehicle that enables a rider to start driving without a sense of discomfort when operating a clutch to perform a start operation.

### Solution to Problem

One aspect of the present invention is a method for controlling an electric two-wheel vehicle, the electric two-wheel vehicle including a motor, a clutch, and a stepped transmission, the method including: a disengagement detecting step of detecting a transition from a state in which the clutch is disengaged to a state in which the clutch is engaged; an accelerator operation detecting step of detecting an amount of accelerator operation performed by a rider after the engagement of the clutch; a target motor rotation speed setting step of setting a target motor rotation speed based on the accelerator operation amount; and a motor rotation speed controlling step of controlling a rotation speed of the motor based on the target motor rotation speed. Note that this specification includes the entire contents of Japanese Patent Application No. 2022-054639 filed on Mar. 29, 2022.

### Advantageous Effects of Invention

According to one aspect of the present invention, a rider can start driving without a sense of discomfort when operating a clutch to perform a start operation.

### BRIEF DESCRIPTION OF DRAWINGS

FIG. 1 is a diagram showing the configuration of an electric two-wheel vehicle.

FIG. 2 is a diagram showing a comparison between the torque characteristic of an internal combustion engine and the torque characteristic of a motor.

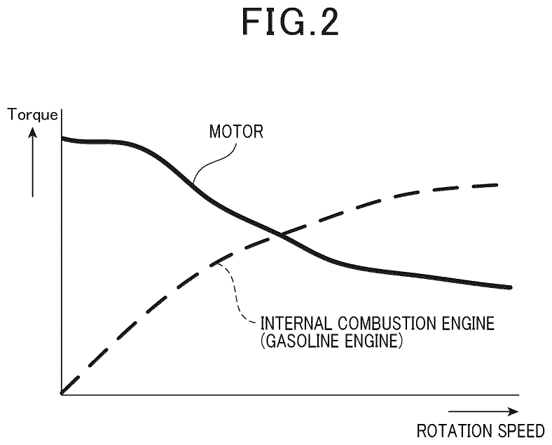

FIG. 3 is a block diagram showing the configuration of an ECU that implements a method for controlling the electric two-wheel vehicle according to an embodiment.

FIG. 4 is a flowchart of output control in the electric two-wheel vehicle.

FIG. 5 is a flowchart of a control method at the time of starting engagement of a clutch.

FIG. 6 is a flowchart showing torque map switching control immediately after the engagement of the clutch.

FIG. 7 is a flowchart showing torque map switching control at the time of a shift to normal traveling.

FIG. 8 is a torque curve of the motor after the output control is performed in accordance with a start required output map.

FIG. 9 is a torque curve of the motor after the output control is performed in accordance with a normal traveling map.

FIG. 10 is a timing chart of a required output and a clutch output rotation speed.

### DESCRIPTION OF EMBODIMENTS

### Embodiment

Hereinbelow, an embodiment of the present invention will be described with reference to the drawings. Unless otherwise mentioned, directions such as front, rear, left, and right in the following description are the same as those directions in a vehicle described below. In addition, at appropriate places in the drawings used in the following description, arrow FR indicating a vehicle front side and arrow UP indicating a vehicle upper side are shown. In the present specification, an electric motor is referred to as a motor.

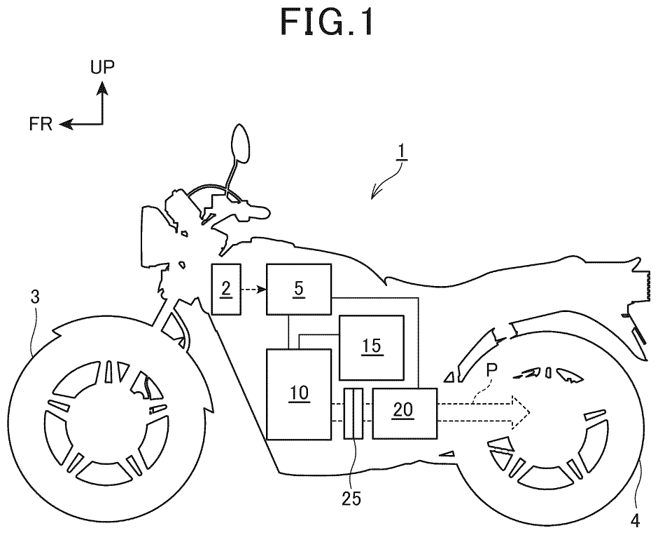

FIG. 1 is a diagram showing a left side face of a saddle-ride vehicle (electric two-wheel vehicle) 1. The saddle-ride vehicle 1 of the present embodiment is an electric two-wheel vehicle including a motor as a power unit instead of an internal combustion engine such as a gasoline engine. As with a motorcycle driven by an internal combustion engine, the saddle-ride vehicle 1 includes a throttle grip, a clutch lever, a gear shift pedal, and the like as an operation system 2 for a rider to control the saddle-ride vehicle 1. The saddle-ride vehicle 1 includes a front wheel 3 as a steering wheel, and a rear wheel 4 as a drive wheel. The rear wheel 4 is supported on a rear portion of a swing arm (not shown) swingably supported on a vehicle body frame (not shown).

The saddle-ride vehicle 1 includes an electronic control unit (ECU) 5 that is a control unit for performing various control operations, a motor 10 that generates a driving force, and a battery 15 that stores electric power. The saddle-ride vehicle 1 includes a clutch 25 and a stepped transmission 20 to transmit the driving force P of the motor 10 to the rear wheel 4. The motor 10 and the stepped transmission 20 are controlled by the ECU 5 that performs control in accordance with an instruction given by a rider to the operation system 2.

Specifically, the ECU 5 is a computer including a processor such as a central processing unit (CPU), a read only memory (ROM) in which programs are written, and a random access memory (RAM) for temporarily storing data. The ECU 5, which is the computer, executes the programs to execute various control means. Instead of or in addition to the ECU 5 described above, the whole or a part of the ECU 5 may be composed of hardware including one or more electronic circuit components.

The motor 10 is a three-phase electric motor or the like. The battery 15 may be a lithium-ion battery or the like. The motor 10 and the battery 15 are fixed to the vehicle body frame. The stepped transmission 20 is a power transmission mechanism including multiple gears in combination to change the rotation speed. The clutch 25 is a device that is mounted between the motor 10 and the stepped transmission 20 and transmits or cuts off the driving force P to the stepped transmission 20. The clutch 25 is operated by the rider operating a clutch lever (not shown).

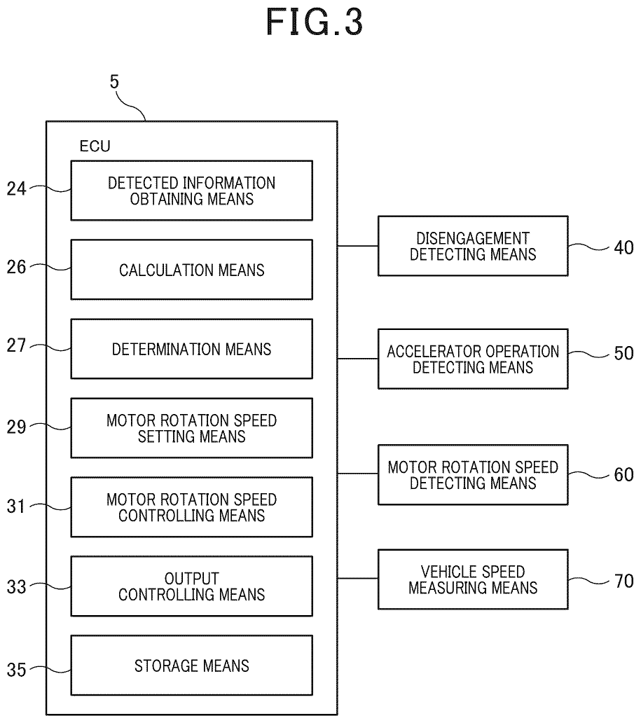

FIG. 3 is a block diagram showing the configuration of the ECU 5 that implements a method for controlling an electric two-wheel vehicle according to the present embodiment. The ECU 5 is connected to a disengagement detecting means 40 for detecting an engagement state of the clutch, and an accelerator operation amount detecting means 50 for detecting the amount of accelerator operation. The ECU 5 is connected to a motor rotation speed detecting means 60 for detecting the motor rotation speed of the motor 10, and a vehicle speed measuring means 70 for measuring the vehicle speed of the saddle-ride vehicle 1.

The ECU 5 includes a detected information obtaining means 24 for obtaining information detected by the various detecting means. The ECU 5 also includes a calculation means 26 for performing a calculation for performing output control based on the obtained information. The ECU 5 performs the output control in accordance with a traveling state or the like and includes a determination means 27 for performing a determination for that purpose. The operation of the determination means 27 will be described further below. The ECU 5 includes a motor rotation speed setting means 29 for setting the motor rotation speed based on a torque map, a motor rotation speed controlling means 31 for controlling the motor 10 such that the motor 10 rotates at the set motor rotation speed, and an output controlling means 33 for controlling the entire output. The operation of each means will be described further below. The ECU 5 also includes a storage means 35 for storing programs and data for implementing the various means and information of the torque map, which will be described further below. The storage means 35 is implemented by a storage device such as a solid state drive (SSD). The detected information obtaining means 24 is implemented by an interface circuit or the like. The calculation means 26, the determination means 27, the motor rotation speed setting means 29, the motor rotation speed controlling means 31, and the output controlling means 33 are implemented by executing the programs stored in the storage means 35.

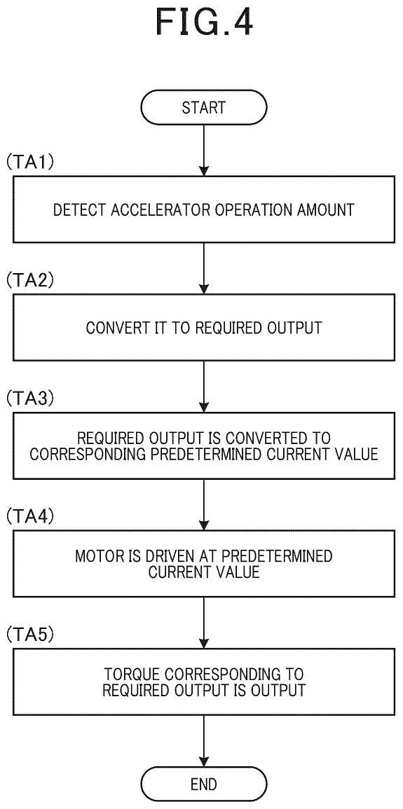

FIG. 4 is a flowchart of the output control in the electric two-wheel vehicle. First, the accelerator operation amount detecting means 50 detects the amount of accelerator operation performed by the rider (step TA1). Specifically, a throttle opening degree in terms of an internal combustion engine is detected from, for example, a rotation angle of the throttle grip. Next, in the ECU 5, the detected information obtaining means 24 obtains the accelerator operation amount from the accelerator operation amount detecting means 50. The calculation means 26 converts the accelerator operation amount to a required output (step TA2). Next, the calculation means 26 converts the required output to a corresponding predetermined current value (step TA3). Then, the output controlling means 33 controls the battery 15 to output the predetermined current value to the motor 10 (step TA4). As a result, a torque corresponding to the required output is output from the motor 10 (step TA5).

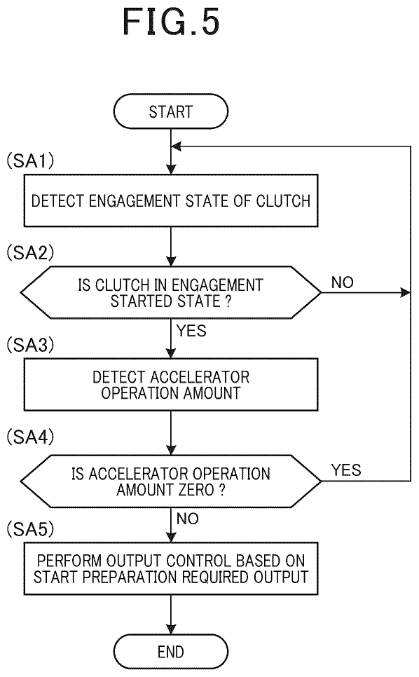

FIG. 5 is a flowchart of the method for controlling the electric two-wheel vehicle at the time of starting engagement of the clutch 25. The ECU 5 obtains an engagement state of the clutch 25 detected by the disengagement detecting means 40 using the detected information obtaining means 24 (step SA1: a disengagement detecting step). The ECU 5 determines whether the clutch 25 is in an engagement started state using the determination means 27 (step SA2: an engagement start detecting step). When it is determined that the clutch 25 is in the engagement started state (step SA2: YES), the ECU 5 obtains the accelerator operation amount detected by the accelerator operation amount detecting means 50 using the detected information obtaining means 24 (step SA3: an accelerator operation detecting step). The ECU 5 determines whether the accelerator operation amount is zero using the determination means 27 (step SA4). When it is determined that the accelerator operation amount is not zero (step SA4: NO), the output controlling means 33 of the ECU 5 performs output control based on a start preparation required output on the battery 15 and the motor 10 (step SA5: an output controlling step). Specifically, the output control includes a target motor rotation speed setting step of setting a target motor rotation speed, and a motor rotation speed controlling step of controlling the motor rotation speed based on the target motor rotation speed, to output the start preparation required output. When it is determined that the clutch 25 is not in the engagement started state (step SA2: NO), a return to step SA1 is made. When it is determined that the accelerator operation amount is zero (step SA4: YES), a return to step SA1 is made.

Here, the start preparation required output is an output value for ensuring that the vehicle speed is generated only up to a vehicle speed of a preset traveling resistance, regardless of the clutch operation state. For example, the start preparation required output is calculated from the magnitude of the traveling resistance, which is mainly rolling resistance, on flat roads.

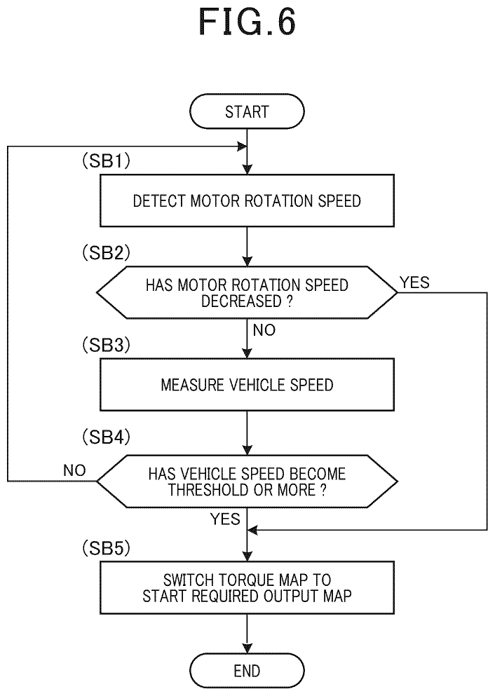

FIG. 6 is a flowchart showing torque map switching control immediately after the engagement of the clutch 25. The storage means 35 may store information on the torque map. The storage means 35 stores a plurality of torque maps in the ECU 5, and the ECU 5 switches the torque map in accordance with the traveling state. The plurality of torque maps may include, for example, a torque map with gentle and reassuring characteristics from start to low-speed traveling and a torque map with torque-full characteristics in a low-medium speed range. When following different torque maps, the saddle-ride vehicle 1 can achieve different flavors of driving. In other words, the output control includes a torque map switching step of switching the torque map followed by the motor 10 based on motor rotation speed and/or the vehicle speed.

First, the torque map switching control immediately after the engagement of the clutch 25 will be described. The ECU 5 obtains information on the motor rotation speed detected by the motor rotation speed detecting means 60 using the detected information obtaining means 24 (step SB1: a motor rotation speed detecting step). The ECU 5 determines whether the motor rotation speed has decreased using the determination means 27 (step SB2). When the determination means 27 determines that the motor rotation speed has not decreased (step SB2: NO), the ECU 5 obtains information on the vehicle speed measured by the vehicle speed measuring means 70 using the detected information obtaining means 24 (step SB3: a vehicle speed measuring step). The ECU 5 determines whether the vehicle speed has become a predetermined threshold or more using the determination means 27 (step SB4). When it is determined that the vehicle speed has become the predetermined threshold or more (step SB4: YES), the output controlling means 33 switches the torque map to a start required output map (step SB5). When the determination means 27 determines that the motor rotation speed has decreased (step SB2: YES), the output controlling means 33 switches the torque map to the start required output map (step SB5: a first switching step). When the determination step 27 determines that the vehicle speed is less than the predetermined threshold (step SB4: NO), a return to step SB1 is made.

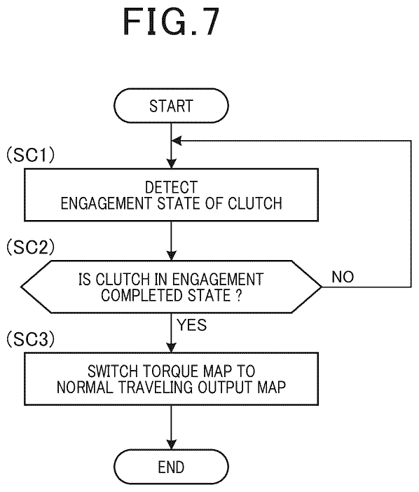

FIG. 7 is a flowchart showing torque map switching control at the time of a shift to normal traveling. The ECU 5 obtains the engagement state of the clutch 25 detected by the disengagement detecting means 40 using the detected information obtaining means 24 (step SC1). The ECU 5 determines whether the clutch 25 is in an engagement completed state using the determination means 27 (step SC2). The clutch engagement completed state at this time may be either a state in which the clutch 25 is fully engaged or a state in which there is no clutch rotation difference. When it is determined that the clutch 25 is in the engagement completed state (step SC2: YES), the output controlling means 33 switches the torque map to a normal traveling map (step SC3: a second switching step). When it is determined that the clutch 25 is not in the engagement completed state (step SC2: NO), a return to step SC1 is made.

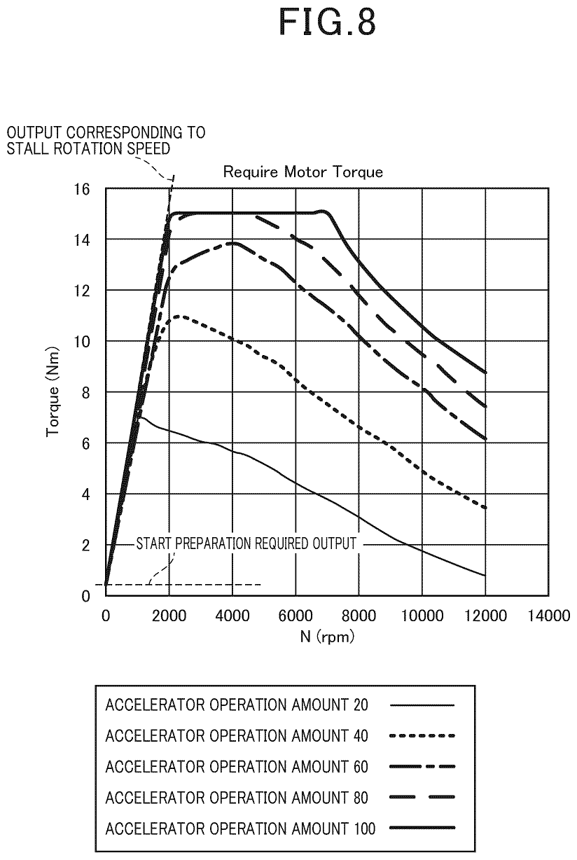

FIG. 8 is a torque curve of the motor after the output control is performed. Specifically, the output control follows the start required output map. The horizontal axis is the rotation speed of the motor, and the vertical axis is the torque amount. The torque curve corresponding to the accelerator operation amount is set. At extremely low rotation speed (around 0 rpm), the output controlling means 33 controls the motor 10 such that the start preparation required output is output. In a low rotation speed range up to 2000 rpm, the output control means 33 controls the motor 10 such that an output corresponding to a stall rotation speed is output. When a normal torque of the motor is transmitted, a large load change occurs when the clutch is engaged, and the rotation speed thus largely decreases. At this time, torque control is performed to prevent the rider from feeling that the engine is stalled.

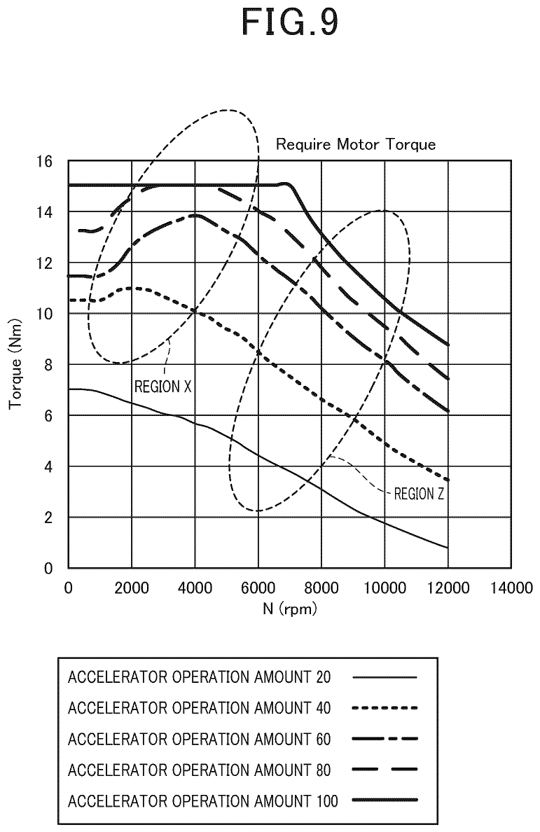

FIG. 9 shows output control following the normal traveling map. The horizontal axis is the rotation speed of the motor, and the vertical axis is the torque amount. The torque curve corresponding to the accelerator operation amount is set. The normal traveling map outputs a larger torque than the start required output map, for example, in the rotation speed range from 4000 rpm to 6000 rpm when the accelerator operation amount is large (region X). Such flavoring enables powerful driving in the medium speed range. In addition, in a region Z in FIG. 9, the map is flavored to reduce torque as the rotation speed increases. This has the effect of prompting shift up when falling out of a region of high motor driving efficiency to return to the region of high driving efficiency.

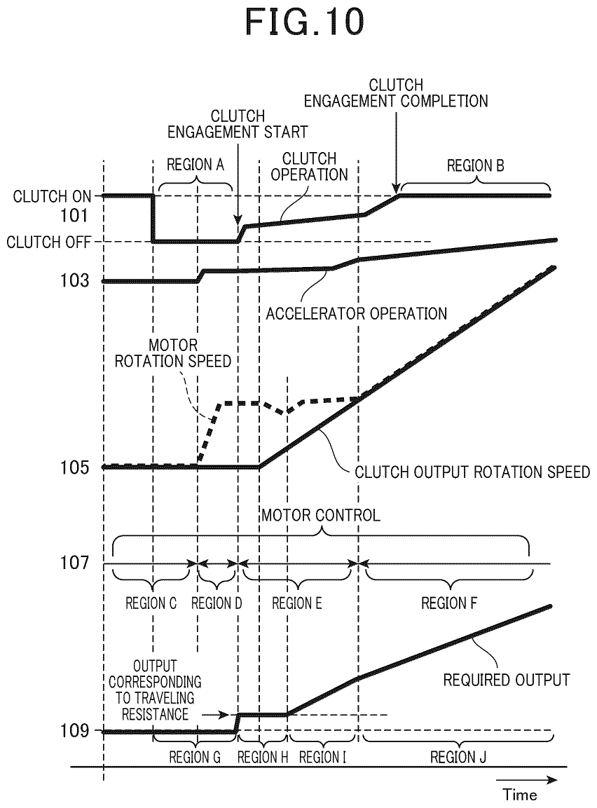

FIG. 10 is a timing chart of the required output and the clutch output rotation speed. A line 101 schematically shows a timing chart of clutch operation performed by the rider. The clutch is in a disengaged state in a region A, and the clutch is in a fully engaged state in a region B. A line 103 schematically shows the amount of accelerator operation performed by the rider at the same time. A line 105 shows the motor rotation speed (dashed line) that is output-controlled in accordance with the accelerator operation amount and the clutch output rotation speed (solid line). A line 107 simply shows the timing of controlling the motor by the output controlling means 33. In a region C, the motor 10 is controlled to zero output. In a region D, the motor 10 performs control to increase the rotation speed in response to an increase in the accelerator operation amount. In a region E, the clutch 25 is in a half-clutch state and shifting to an engaged state. Thus, output control corresponding to the engaged state is performed. Then, in a region F, the clutch 25 is in a fully engaged state. Thus, the torque map is switched to the normal traveling map, and output control following it is performed. A line 109 shows control of the required output. In a region G, the clutch 25 is in a disengaged state, and the required output is thus zero. In a region H, the clutch is in an engagement started state, and an output corresponding to the traveling resistance (start preparation required output) is thus required. In a region I, start acceleration has already started, and the torque map is thus switched to the start required output map. In a region J, the clutch 25 is in a fully engaged state, and the torque map is thus switched to the normal traveling map.

### [Configurations Supported by the Above Embodiment]

The above embodiment supports the following configurations.
(Configuration 1) A method for controlling an electric two-wheel vehicle, the electric two-wheel vehicle including a motor, a clutch, and a stepped transmission, the method including: a disengagement detecting step of detecting a transition from a state in which the clutch is disengaged to a state in which the clutch is engaged; an accelerator operation detecting step of detecting an amount of accelerator operation performed by a rider after the engagement of the clutch; a target motor rotation speed setting step of setting a target motor rotation speed based on the accelerator operation amount; and a motor rotation speed controlling step of controlling a rotation speed of the motor based on the target motor rotation speed. According to such a configuration, it is possible to control a reduction in the rotation speed of the motor caused by load fluctuations when the clutch is engaged. Thus, it is possible to eliminate a sense of discomfort to driving after the clutch operation.
(Configuration 2) The method for controlling the electric two-wheel vehicle according to configuration 1, further including: an engagement start detecting step of detecting start of engagement of the clutch; and an output controlling step of starting output control based on a predetermined start preparation required output when the start of engagement of the clutch is detected in the engagement start detecting step. According to such a configuration, since the load increases in response to the start of engagement of the clutch, the addition of necessary output control can prevent the output from becoming insufficient. In addition, since the control is performed so as to output only the predetermined required output, abrupt start or the like can be prevented. This achieves the excellent effect of enabling safe driving without a sense of discomfort for the rider.
(Configuration 3) The method for controlling the electric two-wheel vehicle according to configuration 2, further including: a motor rotation speed detecting step of detecting a motor rotation speed; a vehicle speed measuring step of measuring a vehicle speed; and a torque map switching step of switching a torque map followed by the motor based on at least one of the motor rotation speed, the vehicle speed, and an engagement state of the clutch. According to such a configuration, the motor characteristics can be switched to an appropriate torque curve in accordance with the traveling state. This achieves the excellent effect of providing an electric two-wheel vehicle that can give the rider the pleasure of freely operating the vehicle as with a motorcycle equipped with an internal combustion engine.
(Configuration 4) The method for controlling the electric two-wheel vehicle according to configuration 3, further including a first switching step of switching the torque map followed by the motor to a start required output map set based on a stall rotation speed of the motor when it is detected that the motor rotation speed has decreased or the vehicle speed has become a predetermined threshold or more after the start of the output control based on the start preparation required output. According to such a configuration, the output characteristic at the time of start can be made similar to the output characteristic of an internal combustion engine. This achieves the effect of reducing the sense of discomfort felt by the rider when the electric two-wheel vehicle starts.
(Configuration 5) The method for controlling the electric two-wheel vehicle according to configuration 3 or 4, further including: an engagement completion detecting step of detecting completion of engagement of the clutch; and a second switching step of switching the torque map followed by the motor to a normal traveling map when the completion of engagement of the clutch is detected in the engagement completion detecting step. Such a configuration enables traveling following the torque curve with high motor efficiency during normal traveling.

Note that the above embodiment shows an aspect to which the present invention is applied, and the present invention is not limited to the above embodiment.

For example, the step units of the operations shown in FIGS. 3, 5, 6, and 7 are divided in accordance with the main processing details to facilitate understanding of the method for controlling the electric two-wheel vehicle, and the present invention is not limited by the way of dividing the processing units or names thereof. Division to more step units may be performed in accordance with the processing details. In addition, division may be performed in such a manner that one step unit includes more processes. The order of the steps may be interchanged as appropriate to the extent that it does not interfere with the gist of the present invention.

### REFERENCE SIGNS LIST

1 saddle-ride vehicle (electric two-wheel vehicle)
10 motor
20 stepped transmission
25 clutch

1. A method for controlling an electric two-wheel vehicle, the electric two-wheel vehicle including a motor, a clutch, and a stepped transmission, the method comprising:
a disengagement detecting step of detecting a transition from a state in which the clutch is disengaged to a state in which the clutch is engaged;
an accelerator operation detecting step of detecting an amount of accelerator operation performed by a rider after the engagement of the clutch;
a target motor rotation speed setting step of setting a target motor rotation speed based on the accelerator operation amount;
a motor rotation speed controlling step of controlling a rotation speed of the motor based on the target motor rotation speed;
an engagement start detecting step of detecting start of engagement of the clutch; and
an output controlling step of starting output control based on a start preparation required output when the start of engagement of the clutch is detected in the engagement start detecting step, the start preparation required output being determined such that a vehicle speed of the electric two-wheel vehicle is generated only up to a vehicle speed of a set traveling resistance.

2. The method for controlling the electric two-wheel vehicle according to claim 1, wherein the output controlling step is executed when it is detected that the accelerator operation amount is not zero after the start of engagement of the clutch is detected in the engagement start detecting step.

3. The method for controlling the electric two-wheel vehicle according to claim 1, further comprising:
a motor rotation speed detecting step of detecting a motor rotation speed;
a vehicle speed measuring step of measuring the vehicle speed; and
a torque map switching step of switching a torque map followed by the motor based on at least one of the motor rotation speed, the vehicle speed, and an engagement state of the clutch.

4. The method for controlling the electric two-wheel vehicle according to claim 3, further comprising a first switching step of switching the torque map followed by the motor to a start required output map set based on a stall rotation speed of the motor when it is detected that the motor rotation speed has decreased or the vehicle speed has become a predetermined threshold or more after the start of the output control based on the start preparation required output.

5. The method for controlling the electric two-wheel vehicle according to claim 3, further comprising:
an engagement completion detecting step of detecting completion of engagement of the clutch; and
a second switching step of switching the torque map followed by the motor to a normal traveling map when the completion of engagement of the clutch is detected in the engagement completion detecting step.
